(19) United States
(12) Patent Application Publication
(10) Pub. No.: US 2018/0054761 A1
(43) Pub. Date: Feb. 22, 2018

(54) METHODS AND SYSTEMS FOR QUALITY OF SERVICE CLASSIFICATION

(71) Applicant: QUALCOMM Incorporated, San Diego, CA (US)

(72) Inventors: Ajay Pathak, Fremont, CA (US); Avneet Kaur Puri, Santa Clara, CA (US); Benjamin Menchaca, Austin, TX (US)

(21) Appl. No.: 15/682,175

(22) Filed: Aug. 21, 2017

Related U.S. Application Data
(60) Provisional application No. 62/378,103, filed on Aug. 22, 2016.

(51) Int. Cl. H04W 28/24; H04L 12/801; H04L 12/851

(52) U.S. Cl. CPC H04W 28/24; H04L 47/41; H04L 47/2433; H04L 47/29

(57) ABSTRACT

Methods, apparatus, and systems disclosed provide for conditional quality of service classification. For example, in some aspects, messages received over a first network interface may be analyzed to reclassify the appropriate quality of service for the messages. Messages received over a second network interface may rely on quality of service information included in the messages themselves, such as quality service information stored in a QOS control field of a media access control header. The quality of service information may also be propagated through one or more protocol layers by including the quality of service information in a memory structured shared, in some aspects, between kernel mode drivers, and user mode network applications. This may provide for the quality of service information to be propagated across multiple nodes in a multi-hop communication path, without experiencing computational overhead associated with multiple reclassifications.

### CROSS REFERENCE TO RELATED APPLICATION(S)

This application claims the benefit of U.S. Provisional Application No. 62/378,103 titled “METHODS AND SYSTEMS FOR QUALITY OF SERVICE CLASSIFICATION,” filed Aug. 22, 2016. The content of this prior application is considered part of this application and is hereby incorporated by reference in its entirety.

### TECHNICAL FIELD

The present application relates generally to wireless communications, and more specifically to systems, methods, and devices for communicating control information.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. In some aspects, devices may transmit control information in order to better facilitate communication between the devices. However, in some aspects, such information may increase overhead and reduce efficiency. Accordingly, there is a need for improved methods and devices for communicating such information between devices.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention allow for efficient use of the wireless communication medium.

One aspect disclosed is an apparatus for classifying a quality of service of a network message. The apparatus includes a first network interface, a second network interface, an electronic hardware processor, operably connected to the first and second network interfaces, and configured to receive a message from either the first network interface or the second network interface, the message comprising data and a quality of service indication for the data, determine a quality level of the quality of service indication based on whether the message was received from either the first or second network interface, reclassify the quality of service of the received message in response to the quality level being below a threshold; and process the message according to its quality of service.

In some aspects, the electronic hardware processor is further configured to process the message according to the reclassified quality of service if the quality level is below the threshold, and to process the message according to the quality of service of the received message otherwise. In some aspects, processing the message according to its quality of service comprises selecting a prioritized transmission queue of a plurality of prioritized transmission queues based on the quality of service, and transmitting a packet derived from the message in response to the message reaching a front of the prioritized transmission queue. In some aspects, the electronic hardware processor is configured to generate the packet to indicate the quality of service in a quality of service control field of the packet. In some aspects, the electronic hardware processor is configured to process the message according to its quality of service by storing the quality of service in a memory configured to be accessed by the electronic hardware processor when operating in both a user mode or in a kernel mode, and transferring the data to a network application, wherein the electronic hardware processor is configured to run the network application in the user mode, and is configured to receive the message from the first network interface in the kernel mode. In some aspects, the electronic hardware processor is configured to execute a linux operating system, and the memory is a socket buffer.

In some aspects, the electronic hardware processor is further configured to receive a second message from the second network interface, the second message comprising second data and a second quality of service indication for the second data, determine a second quality level of the second quality of service indication received from the second network interface, reclassify the second quality of service of the received second message in response to the second quality level being below the threshold, and process the second message according to its respective second quality of service.

Another aspect disclosed is a method of classifying a quality of service of a network message. The method includes receiving, via an electronic hardware processor, a message from a physical network interface of a plurality of physical network interfaces, the message comprising data and a quality of service indication for the data, determining, via the electronic hardware processor, a quality level of the quality of service indication received from the first physical network interface, reclassifying the quality of service of the received message in response to the quality level being below a threshold, and processing the message according to its quality of service. In some aspects, the method includes processing the message according to the reclassified quality of service if the quality level is below the threshold, and processing the message according to the quality of service of the received message otherwise. In some aspects, processing the message according to its quality of service comprises selecting a prioritized transmission queue of a plurality of prioritized transmission queues based on the quality of service, and transmitting a packet derived from the message in response to the message reaching a front of the prioritized transmission queue. In some aspects, the method includes generating the packet to indicate the quality of service in a quality of service control field of the packet.

Another aspect disclosed is a method of classifying network traffic. The method includes receiving, via an electronic device, a message for transmission from a network application, the message including data, determining a quality of service for the data by analyzing the data in response to no quality of service indication for the data being received from the network application, generating a frame, the frame comprising the data, and the quality of service indication for the data, and transmitting the frame onto a wireless network in accordance with the quality of service indication. In some aspects, the method includes generating the frame to indicate the quality of service in a QOS control field. In some aspects, transmitting the frame onto the wireless network in accordance with the quality of service indication comprises selecting a particular prioritized transmission queue of a plurality of prioritized transmission queues based on the quality of service indication, queuing the frame on the selected prioritized transmission queue, transmitting the frame in response to the frame reaching a front of the selected prioritized transmission queue.

In some aspects, analyzing the data to determine the quality of service comprises basing the quality of service on one or more of a source or destination port, or signature of the data. In some aspects, the message is received in a kernel mode and the network application is running in a user mode, further comprising determining whether the quality of service for the data is received from the network application based on meta data accessible in both kernel mode and user mode. In some aspects, the meta data is a Linux socket buffer.

Another aspect disclosed is an apparatus for classifying network traffic. The apparatus includes an electronic hardware processor, configured to: receive a message for transmission from a network application, the message including data, determine a quality of service for the data by analyzing the data in response to no quality of service indication for the data being received from the network application, generate a frame, the frame comprising the data, and the quality of service indication for the data; and a transmitter configured to transmit the frame onto a wireless network in accordance with the quality of service indication.

In some aspects, the electronic hardware processor is further configured to generate the frame to indicate the quality of service in a QOS control field. In some aspects, transmitting the frame onto the wireless network in accordance with the quality of service indication comprises: selecting a particular prioritized transmission queue of a plurality of prioritized transmission queues based on the quality of service indication, queuing the frame on the selected prioritized transmission queue, transmitting the frame in response to the frame reaching a front of the selected prioritized transmission queue.

In some aspects, analyzing the data to determine the quality of service comprises basing the quality of service on one or more of a source or destination port, or signature of the data. In some aspects, the message is received by the electronic hardware processor operating in a kernel mode and the electronic hardware processor is configured to run the network application a user mode, and the electronic hardware processor is further configured to determine whether the quality of service for the data is received from the network application based on meta data accessible to the electronic hardware processor in both kernel mode and user mode. In some aspects, the meta data is a Linux socket buffer.

### BRIEF DESCRIPTION OF THE DRAWINGS

FIG. 1 illustrates an example of a wireless communication system in which aspects of the present disclosure may be employed.

FIG. 2 illustrates a block diagram of the access point 110 and two user terminals 120m and 120x in a MIMO system.

FIG. 3 illustrates various components that may be utilized in a wireless device that may be employed within a wireless communication system.

FIG. 4 is an example frame format for an 802.11 packet.

FIG. 5 is a network block diagram showing how classified data may be transmitted across a network.

FIG. 6 is a flowchart of a method of processing a message received from a physical link interface.

FIG. 7 is a flowchart of a method of transmitting a message on a network.

FIG. 8 is a flowchart of a method of transmitting a message on a network.

### DETAILED DESCRIPTION

Various aspects of the novel systems, apparatuses, and methods are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes.

In some implementations, a WLAN includes various devices which are the components that access the wireless network. For example, there may be two types of devices: access points (“APs”) and clients (also referred to as stations, commonly known as “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Network messages may compete for resources, such as available bandwidth, during their transmission from a source node to a destination node. Quality of service classifications of the packets may be utilized to prioritize network messages when the number of messages pending for transmission exceeds a networks current availability. The quality of service classifications may vary in quality. In some cases, there may be no quality of service classification for a particular message. In some other cases, the available classification may be inaccurate or unreliable.

Furthermore, in some cases, quality of service indications present at a physical network layer may not be propagated through network layers in a protocol stack. As a result, quality of service classifications may be lost as a message moves along a multi-hop communication path towards its destination.

The disclosed methods and systems solve these problems in a number of ways. First, the methods and systems may extract quality of service information that exists at a physical packet layer and propagate this information through various layered protocol modules, via innovative data passing methods, such that the received quality of service indications can be considered. The quality of service information may also be passed back to a network driver, such that the quality of service indication can be set again at the physical layer in the event the message is retransmitted, for example, as may be the case of a repeater device.

Furthermore, in some aspects, the disclosed methods and systems may distinguish between messages received over a first network interface, and those messages received over a second network interface. For example, in some aspects, the first network interface may receive messages transmitted by a wide area network. The source of these messages may be varied, and unreliable. As such, the disclosed methods and systems may reclassify quality of service information for these messages, in some aspects, whether a quality of service is indicated in the message or not. In contrast, the second network interface may receive messages from a more finite or known set of source devices, such as one or more access points or network controllers. These devices may be known to provide high quality of service indications in messages they send. As such, some implementations of the disclosed methods and systems may utilize a quality of service indication provided in these messages and ensure these indications are propagated through multiple protocol stack layers, and in other network messages that may be generated as a result of the reception of messages from the second network interface.

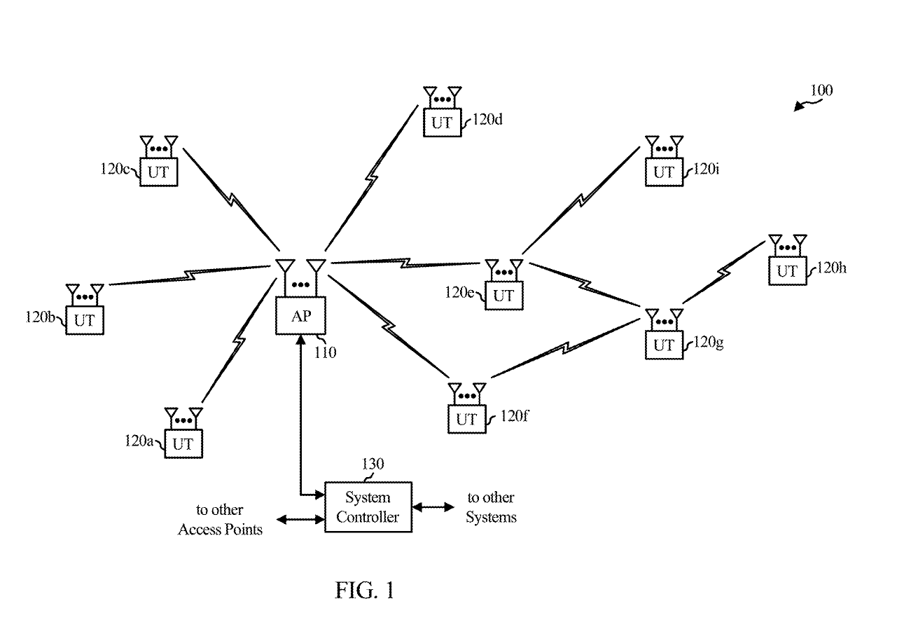

FIG. 1 is a diagram that illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or using some other terminology. A user terminal or STA may be fixed or mobile and may also be referred to as a mobile station or a wireless device, or using some other terminology. The access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, the AP 110 may be configured to communicate with both SDMA and non-SDMA user terminals. This approach may conveniently allow older versions of user terminals (“legacy” stations) that do not support SDMA to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nap antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nap≦K≦1 if the data symbol streams for the K user terminals are not multiplexed in code, frequency or time by some means. K may be greater than Nap if the data symbol streams can be multiplexed using TDMA technique, different code channels with CDMA, disjoint sets of sub-bands with OFDM, and so on. Each selected user terminal may transmit user-specific data to and/or receive user-specific data from the access point. In general, each selected user terminal may be equipped with one or multiple antennas (i.e., Nut 1). The K selected user terminals can have the same number of antennas, or one or more user terminals may have a different number of antennas.

The SDMA system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, where each time slot may be assigned to a different user terminal 120.

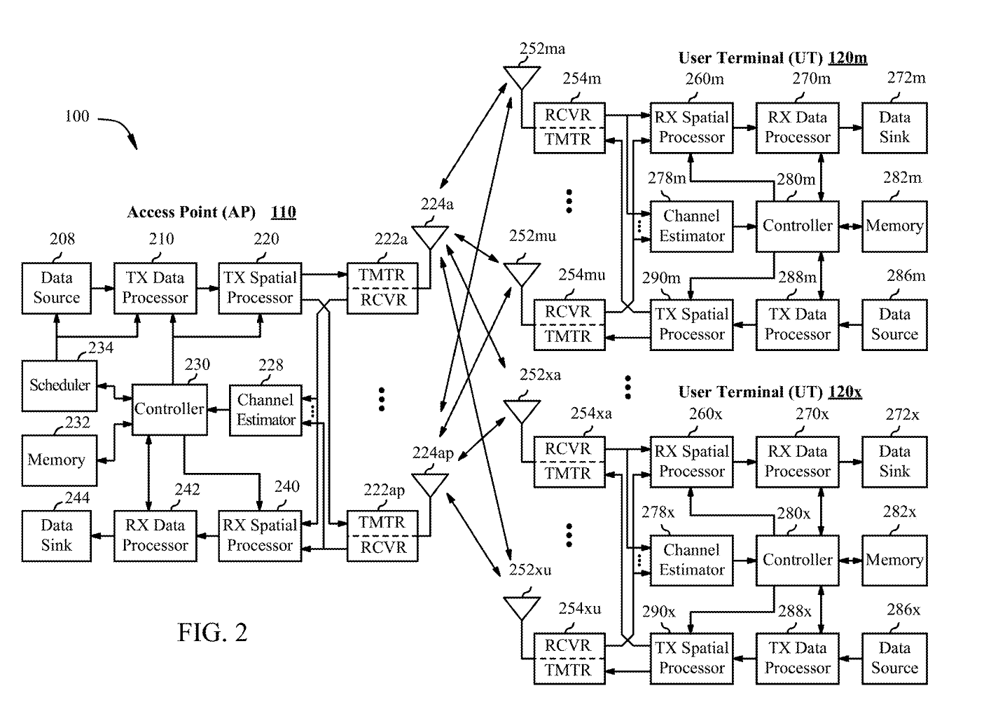

FIG. 2 illustrates a block diagram of the access point 110 and two user terminals 120m and 120x in MIMO system 100. The access point 110 is equipped with Nt antennas 224a through 224ap. The user terminal 120m is equipped with Nut,m antennas 252ma through 252mu, and the user terminal 120x is equipped with Nut,x antennas 252xa through 252xu. The access point 110 is a transmitting entity for the downlink and a receiving entity for the uplink. The user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup user terminals are selected for simultaneous transmission on the uplink, and Ndn user terminals are selected for simultaneous transmission on the downlink. Nup may or may not be equal to Ndn, and Nup and Ndn may be static values or may change for each scheduling interval. Beam-steering or some other spatial processing technique may be used at the access point 110 and/or the user terminal 120.

On the uplink, at each user terminal 120 selected for uplink transmission, a TX data processor 288 receives traffic data from a data source 286 and control data from a controller 280. The TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides Nut,m transmit symbol streams for the Nut,m antennas. Each transmitter unit (TMTR) 254 receives and processes (e.g., converts to analog, amplifies, filters, and frequency upconverts) a respective transmit symbol stream to generate an uplink signal. Nut,m transmitter units 254 provide Nut,m uplink signals for transmission from Nut,m antennas 252, for example to transmit to the access point 110.

Nup user terminals may be scheduled for simultaneous transmission on the uplink. Each of these user terminals may perform spatial processing on its respective data symbol stream and transmit its respective set of transmit symbol streams on the uplink to the access point 110.

At the access point 110, Nup antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nup received symbol streams from Nup receiver units 222 and provides Nup recovered uplink data symbol streams. The receiver spatial processing may be performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at the access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. The TX data processor 210 provides Ndn downlink data symbol streams for the Ndn user terminals. A TX spatial processor 220 performs spatial processing (such as a precoding or beamforming) on the Ndn downlink data symbol streams, and provides Nup transmit symbol streams for the Nup antennas. Each transmitter unit 222 receives and processes a respective transmit symbol stream to generate a downlink signal. Nup transmitter units 222 may provide Nup downlink signals for transmission from Nup antennas 224, for example to transmit to the user terminals 120.

At each user terminal 120, Nut,m antennas 252 receive the Nup downlink signals from the access point 110. Each receiver unit 254 processes a received signal from an associated antenna 252 and provides a received symbol stream. An RX spatial processor 260 performs receiver spatial processing on Nut,m received symbol streams from Nut,m receiver units 254 and provides a recovered downlink data symbol stream for the user terminal 120. The receiver spatial processing may be performed in accordance with the CCMI, MMSE, or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix Hdn,m for that user terminal. Controller 230 derives the spatial filter matrix for the access point based on the effective uplink channel response matrix Hup,eff. The controller 280 for each user terminal may send feedback information (e.g., the downlink and/or uplink eigenvectors, eigenvalues, SNR estimates, and so on) to the access point 110. The controllers 230 and 280 may also control the operation of various processing units at the access point 110 and user terminal 120, respectively.

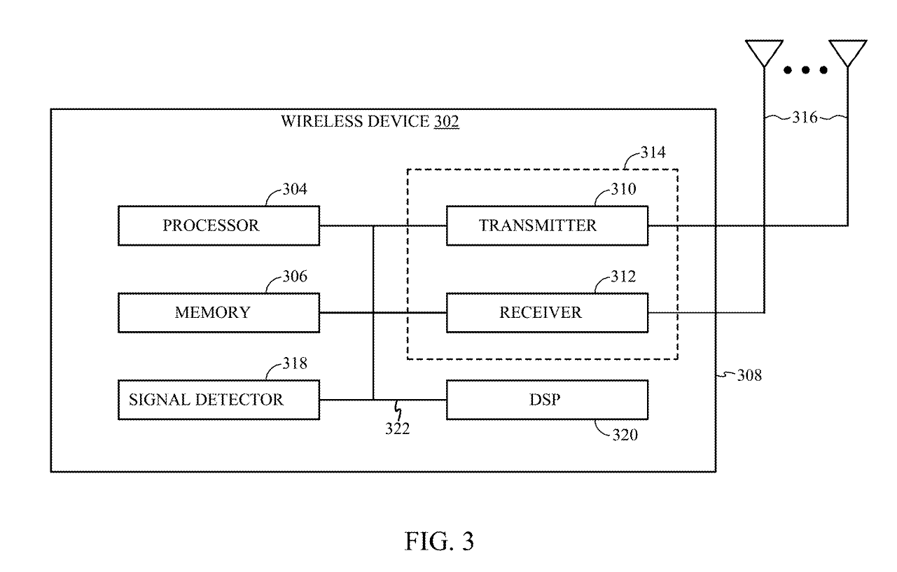

FIG. 3 illustrates various components that may be utilized in a wireless device 302 that may be employed within the wireless communication system 100. The wireless device 302 is an example of a device that may be configured to implement the various methods described herein. The wireless device 302 may implement an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transceiver antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

In some aspects, a wide range of control information may be exchanged between STAs and/or APs using an 802.11 protocol. For example, STAs may exchange buffer status (BS) feedback, channel quality information feedback, resource allocation, power save (PS) feedback, etc. in order to facilitate more efficient communication between wireless devices. This control information may be required to be signaled somewhere within exchanged frames between the STAs and/or APs. In some aspects, including this information in various containers (e.g., frames, element, fields) may add to design complexity. Additionally, including this control information in an aggregation of multiple types of frames (e.g., control, management, data, etc.) may increase medium access control (MAC) MAC overhead. Accordingly, it may be beneficial to define a new type of control field in a MAC frame in order to better exchange such control information. In such a new type of control field, the control field may comprise one or more control fields carrying a variety of control information in one or more MAC frames. In addition, the new type of control field may indicate the end of the one or more control frames and may be generated to include a variable amount of information in each control field.

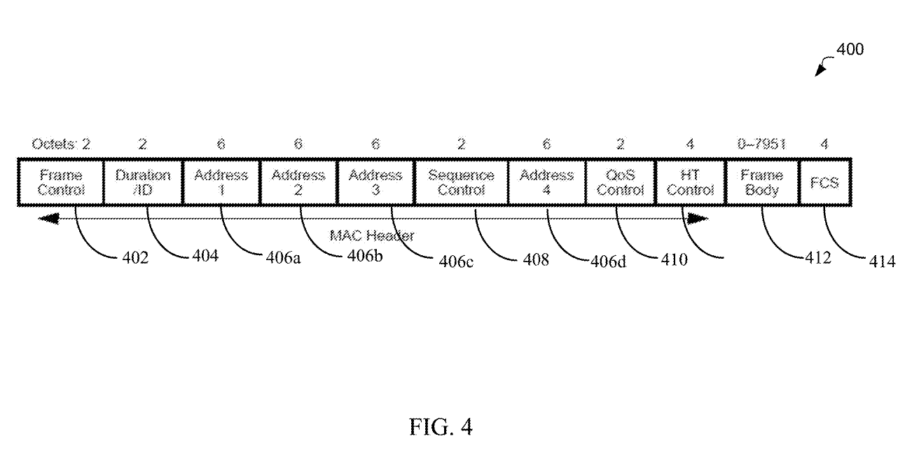

FIG. 4 is an example frame format for an 802.11 packet. The frame 400 includes several fields, including a frame control field 402, duration field 404, address fields 406a-d, sequence control field 408, quality of service control field 410, HT control field 412, a frame body 414, and a frame check sequence field 416. Some aspects of the methods and systems disclosed may read and or write data in the format shown for frame 400, and/or to one or more of the fields discussed above. In particular, the QOS control field 410 may carry quality of service information that is written to or read by the disclosed methods and systems.

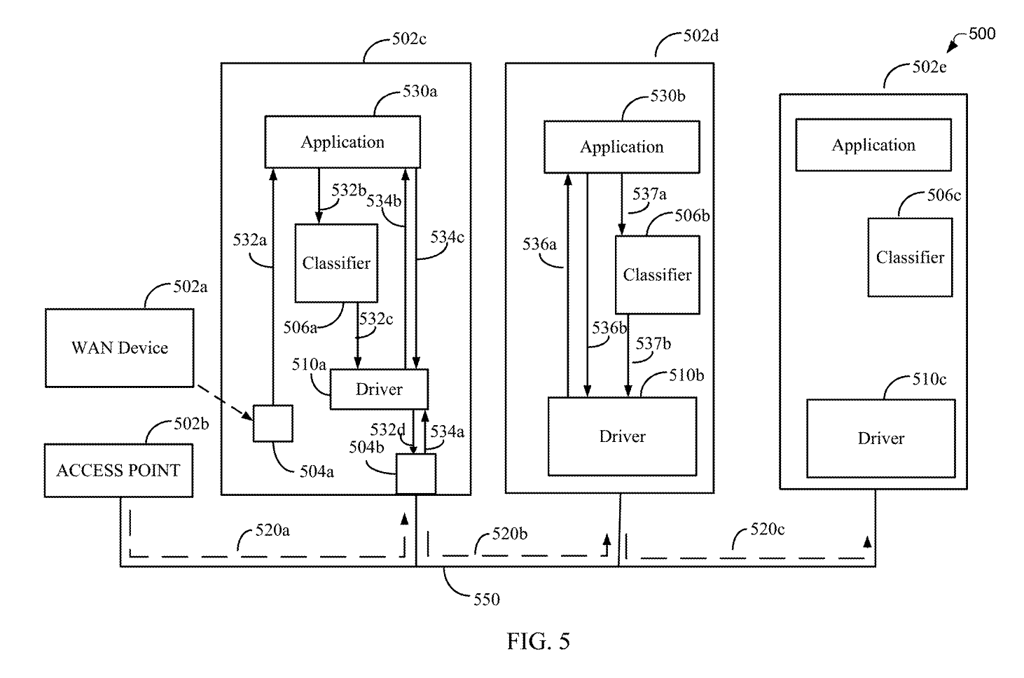

FIG. 5 is a network block diagram showing how quality of service information for network data may be transmitted across a network. The diagram 500 shows five devices 505a-e performing network communication.

Device 502c receives data from two devices, a WAN device 502a, and an access point 502b. The data is received over two different physical network interfaces respectively, shown as 504a-b. Data received by the device 502c may be forwarded over the network 550 to device 502d. Device 502d may relay data received from device 502c to device 502e in some aspects.

The device 502c may determine whether data is provided to a classifier 506a based on whether the data is received from the network interface 504a or the network interface 504b. For example, in some aspects, data received from a wide area network device over interface 504a may be reclassified before being transmitted over the network 550. This is shown in FIG. 5 by data flow 532, including components 532a-d. FIG. 5 illustrates that after data is received by the interface 504a, it is provided to the network application 530a via data flow 532a. The network application 530a then provides the data to a classifier 506a via data flow 532b. The classifier may determine a new quality of service for the data by analyzing the data. For example, the classifier may determine a new quality of service based on which source or destination network ports are specified for the data. Alternatively, or in addition, the classifier may rely on a database of protocol signatures, and compare the known signatures to signatures of the data, to determine the best classification for the data. For example, a first streaming application may produce data with a first signature, while a second texting application may produce data with a second signature. A similarity score may be generated between a signature of the data and the known signatures for the first and second applications. The classification of the data may be based on the similarity score. The classifier then provides the data to a driver 510a via data flow 532c. The driver may then sent the data to device 502d via data flow 532d and network interface 504b

In contrast, second data received from the access point 502b over the network 550, via network interface 504b, may not be reclassified when retransmitted over the network 550, for example, to device 502d. This lack of reclassification may be based on the second data being received over interface 504b and not 504a as was the case with first data discussed above.

This is illustrated by data flow 534, including components 534a-d. After data is received from network interface 504b, it is received by the driver 510a via data flow 534a. The driver may recognize that the second data includes quality of service information, either based on the fact the second data was received over interface 504b from the access point 502b, or based on a value of a QOS field in a network packet including the second data. The driver then sends the second data to the application 530a via flow 534b. The network application 530a may then determine the second data is to be forwarded or relayed to device 502d. Therefore, application 530a sends the second data directly back to the driver 510a over data flow 534c. In some aspects, data flow 534c includes quality of service information equivalent to that received from data flow 534a. Thus, the QOS information is preserved as the data flows through the device c.

Upon receiving the data from the device 502c over flow 520b on network 550, the driver 510b of device 502d may extract the QOS information from the data packet. In some aspects, the QOS information may be extracted from the QOS control field 410, discussed above with respect to FIG. 4.

The driver 510b include the QOS information in a data flow from the driver 510b to the application 530b. This is shown as data flow 536a. Because the QOS information is already available in the data flow 536, if the application 530b determines the data on flow 536a should be relayed to another device 502e, the data may be sent back to the driver 510b via data flow 536b. Alternatively, data without QOS classification information in the data flow 536a may be sent to the classifier 506b via data flow 537a before being sent to the driver via data flow 537b. The driver 510b may then include the classification in a packet transmitted onto the network 550, for example, in some aspects, in a QOS control field 410 of the packet as discussed above with respect to FIG. 4.

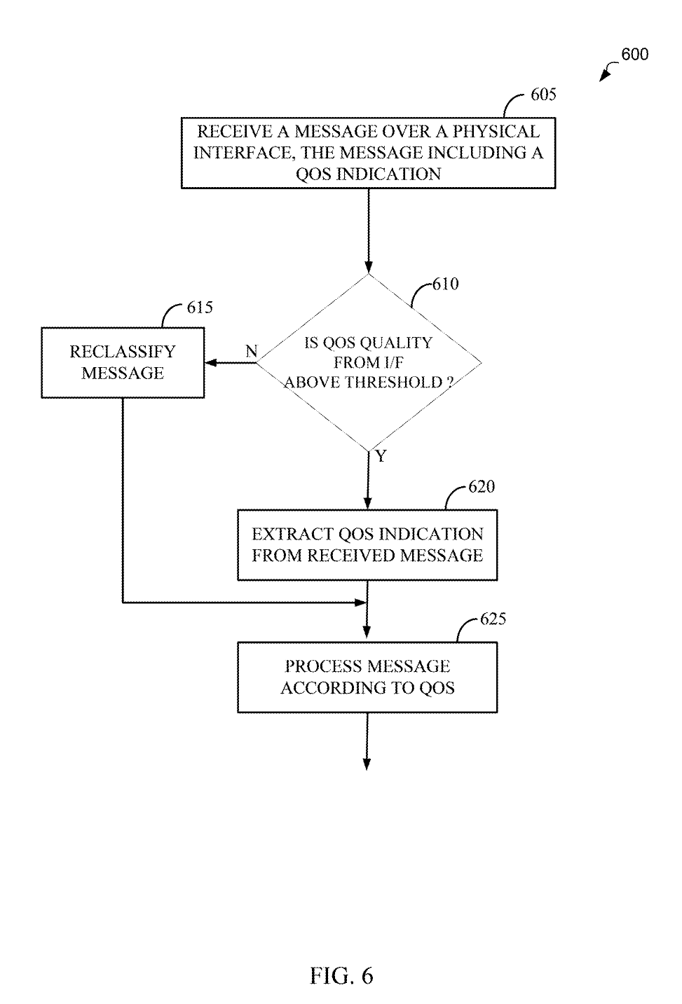

FIG. 6 is a flowchart of a method of processing a message received from a physical link interface. In some aspects, one or more of the functions discussed below with respect to process 600 may be performed by the device 302. For example, instructions stored in the memory 306 may configure the electronic hardware processor 304 to perform one or more of the functions.

In block 605, a message is received over a physical link interface from a network. For example, a message may be received over either the interface 504a or the interface 504b discussed above with respect to FIG. 5. The message may include a QOS indication. For example, the message may include the packet 400, discussed above with respect to FIG. 4, and may include the QOS control field 410 in some aspects. The QOS indication may be located in a header portion of the message, and not in a body portion of the message. For example, the indication may be in physical header or a media access control header of the message. In some aspects, the indication may not be in an Internet Protocol header or a TCP header, or a TCP application header (such as a RTSP header or HTTP header) of the message.

In decision block 610, process 600 determines whether messages received from the first physical interface include QOS indications that are above a quality threshold. To make this determination, process 600 may rely on configuration data, indicating, directly or indirectly, whether QOS indications received from a particular physical interface should be relied upon, or whether new classifications of quality of service should be obtained for data received over that particular interface. Thus, in some aspects, data received over a first interface may be subject to classification or reclassification, despite, in some aspects, having classification information included in the message, such as the QOS control field 410 of FIG. 4. Data received over a second interface may not be subject to classification or reclassification. Instead, process 600 may rely on a classification included in the message, such as in the QOS control field 410. As such, if the QOS quality from the first interface satisfies (is above, below, equal to, or some logical combination) the threshold, a QOS indication is extracted from the received message.

In block 625, the message is processed according to the applicable quality of service indication. For example, the message may be processed according to a QOS classification generated by block 615, or from the message, as extracted in block 620. Processing the message may include transmitting the message or a second message derived from the message over a network according to the QOS classification. For example, the transmitted message may first be queued to one of a plurality of transmission queues based on the QOS indication. Each queue may be for a particular, or set of QOS classifications. Data in some of the queues may be transmitted at a higher priority that data in other of the queues. In some aspects, the transmission of the message may include writing the QOS indication to the message itself, for example, to a physical or media access control header portion of the message. In some aspects, the QOS indication may be written to the QOS control field 410, as discussed above with respect to FIG. 4 before the message is transmitted.

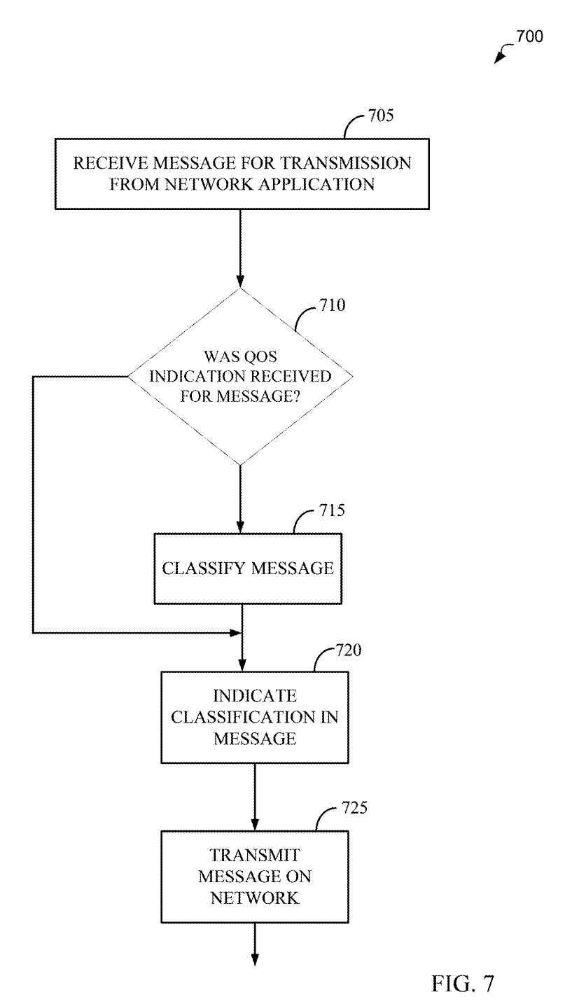

FIG. 7 is a flowchart of a method of transmitting a message on a network. In some aspects, one or more of the functions discussed below with respect to process 700 may be performed by the device 302. For example, instructions stored in the memory 306 may configure the electronic hardware processor 304 to perform one or more of the functions. In some aspects, process 700 may be performed by a device utilizing an operating system including a kernel space and distinct user space, each of these environments having different security parameters. For example, the Linux operating system utilizes kernel space and user space environments.

In block 705, a message is received for transmission from a network application. For example, in some aspects, the message may be received by a kernel space process from a user space network application. As such, the ability for the user space and kernel space processes to share information may be limited. For example, the user space network application may be prevented from writing data into the kernel space application's memory space.

Decision block 710 determines whether a quality of service (QOS) indication was received for the message. For example, in some aspects, the network application may optionally include a quality of service indication in a socket buffer (SKB), which is a portion of memory allocated for communication between a user space sockets application, such as, in some aspects, application 530a or 530b discussed above with respect to FIG. 5, and a kernel mode network driver, such as, in some aspects, any of the drivers 510a-c discussed above with respect to FIG. 5. If a quality of service indication is included, for example, in some aspects, in the socket buffer, decision block 710 may determine that a QOS indication was received for the message, and transition to block 720. Otherwise, if no QOS identification is identified, process 700 moves to block 715, which performs QOS classification on the message. Process 700 then moves to block 720, which indicates the appropriate classification in the message. For example, the classification received in the socket buffer (in some aspects), or the classification generated by the classifier in block 715. In some aspects, the classification is indicated in the QOS control field 410, discussed above with respect to FIG. 4.

In block 725, the message is transmitted on the network. In some aspects, the message is transmitted according to the QOS indication. For example, the message may be placed in one of a plurality of prioritized transmission queues in accordance with the QOS indication. Thus, the process 700 discussed above may provide a way to ensure that a quality of service determined by the network application referenced in block 705, directly influences a prioritized transmission queue for physical transmission of the message over a physical network link.

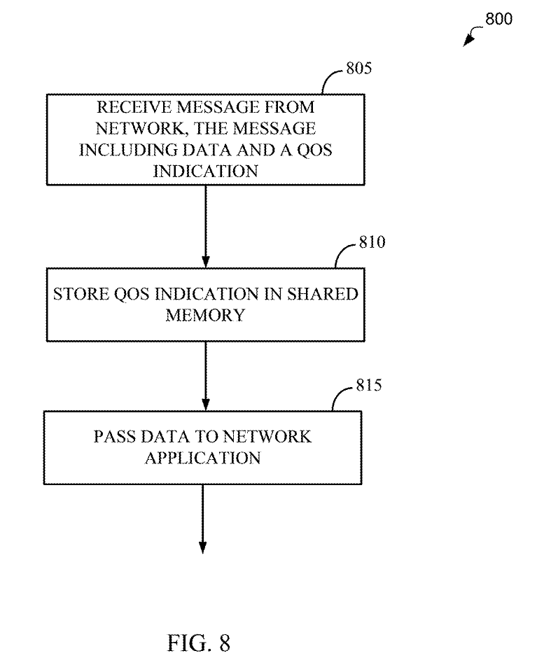

FIG. 8 is a flowchart of a method of transmitting a message on a network. In some aspects, one or more of the functions discussed below with respect to process 800 may be performed by the device 302. For example, instructions stored in the memory 306 may configure the electronic hardware processor 304 to perform one or more of the functions. In some aspects, process 800 may be performed by a device utilizing an operating system including a kernel space and distinct user space, each of these environments having different security parameters. For example, the Linux operating system utilizes kernel space and user space environments.

In block 805, a message is received from a network. The message may include data, such as data that may be present in the frame body field 412, discussed above with respect to FIG. 4, and a quality of service indication for the data, such as might be stored in the QOS control field 410, also discussed above with respect to FIG. 4. In some aspects, the message may be received into a kernel mode space, such as a memory accessible only to kernel mode processes.

In block 810, the quality of service indication is extracted from the message and stored in shared memory. In some aspects, the memory may be accessible to both kernel mode processes and user mode processes. In some aspects, the memory may be part of a socket buffer, as utilized in sockets applications, such as those implemented in a Linux operating system.

In block 815, the data included in the message is passed to a network application. In some aspects, the network application is a user space application running on a Linux operating system. The data may be passed from a kernel mode process, such as a network driver, to the user space application. By providing the QOS indication received in the message of block 805, via shared memory, to the network application, process 800 may provide at least a portion of a solution that allows QOS information to propagate across multiple devices in a multi-hop communication path between a source of data and an end recipient node of the data, at a quality of service along the network path provided for by the QOS indication.

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-7 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for classifying a quality of service of a network message, the apparatus comprising:
a first network interface and a second network interface for receiving messages over a network; and
an electronic hardware processor configured to:
receive a message, over the first network interface or over the second network interface, the message including a quality indicator for the message;
compare a reliability level for the quality indicator with a threshold, the reliability level for the quality indicator being greater if the message is received over the second network interface than if the message is received over the first network interface;
classify a quality of service for the message, the classified quality of service being based on the quality indicator included in the message if the reliability level is greater than or equal to the threshold, and the classified quality of service being based on application data stored at the apparatus if the reliability level is less than the threshold;
generate a packet for indicating the classified quality of service for the message over the network; and
transmit the packet over the network based on the classified quality of service.

2. The apparatus of claim 1, the first network interface being configured to receive messages from a first set of devices having a first reliability level, and the second network interface being configured to receive messages from a second set of devices having a second reliability level greater than the first reliability level.

3. The apparatus of claim 1, wherein if the reliability level is greater than or equal to the threshold, the classifying the quality of service for the message comprises extracting one or more values from the quality indicator included in the message.

4. The apparatus of claim 1, wherein if the reliability level is less than the threshold, the classifying the quality of service for the message comprises reclassifying one or more values from the quality indicator included in the message based on the application data stored at the apparatus.

5. The apparatus of claim 4, wherein the application data comprises one or more of a source network port for the message, a destination network port for the message, and a protocol signature database stored at the apparatus.

6. The apparatus of claim 1, wherein the transmitting the packet over the network based on the classified quality of service comprises transmitting the packet according to a transmission priority.

7. The apparatus of claim 1, further comprising generating the packet to indicate the classified quality of service for the message in a quality of service control field of the packet.

8. A method for classifying a quality of service of a network message, the method comprising:
receiving a message, over a first network interface or over a second network interface, the message including a quality indicator for the message;
comparing a reliability level for the quality indicator with a threshold, the reliability level for the quality indicator being greater if the message is received over the second network interface than if the message is received over the first network interface;
classifying a quality of service for the message, the classified quality of service being based on the quality indicator included in the message if the reliability level is greater than or equal to the threshold, and the classified quality of service being based on application data if the reliability level is less than the threshold;
generating a packet for indicating the classified quality of service for the message over the network; and
transmitting the packet over the network based on the classified quality of service.

9. The method of claim 8, further comprising receiving messages, over the first network interface, from a first set of devices having a first reliability level, and receiving messages, over the second network interface, from a second set of devices having a second reliability level greater than the first reliability level.

10. The method of claim 8, wherein if the reliability level is greater than or equal to the threshold, the classifying the quality of service for the message comprises extracting one or more values from the quality indicator included in the message.

11. The method of claim 8, wherein if the reliability level is less than the threshold, the classifying the quality of service for the message comprises reclassifying one or more values from the quality indicator included in the message based on the application data.

12. The method of claim 11, wherein the application data comprises one or more of a source network port for the message, a destination network port for the message, and a protocol signature database.

13. The method of claim 8, wherein the transmitting the packet over the network based on the classified quality of service comprises transmitting the packet according to a transmission priority.

14. The method of claim 8, further comprising generating the packet to indicate the classified quality of service for the message in a quality of service control field of the packet.

15. An apparatus for classifying a quality of service of a network message, the apparatus comprising:
means for receiving a message, over a first network interface or over a second network interface, the message including a quality indicator for the message;
means for comparing a reliability level for the quality indicator with a threshold, the reliability level for the quality indicator being greater if the message is received over the second network interface than if the message is received over the first network interface;
means for classifying a quality of service for the message, the classified quality of service being based on the quality indicator included in the message if the reliability level is greater than or equal to the threshold, and the classified quality of service being based on application data if the reliability level is less than the threshold;
means for generating a packet for indicating the classified quality of service for the message over the network; and
means for transmitting the packet over the network based on the classified quality of service.

16. The apparatus of claim 15, further comprising means for receiving messages, over the first network interface, from a first set of devices having a first reliability level, and means for receiving messages, over the second network interface, from a second set of devices having a second reliability level greater than the first reliability level.

17. The apparatus of claim 15, wherein if the reliability level is greater than or equal to the threshold, the classifying the quality of service for the message comprises extracting one or more values from the quality indicator included in the message.

18. The apparatus of claim 15, wherein if the reliability level is less than the threshold, the classifying the quality of service for the message comprises reclassifying one or more values from the quality indicator included in the message based on the application data.

19. The apparatus of claim 18, wherein the application data comprises one or more of a source network port for the message, a destination network port for the message, and a protocol signature database.

20. The apparatus of claim 15, wherein the means for transmitting the packet over the network based on the classified quality of service comprises means for transmitting the packet according to a transmission priority.

21. The apparatus of claim 15, further comprising means for generating the packet to indicate the classified quality of service for the message in a quality of service control field of the packet.
